(19) United States
(12) Patent Application Publication
(10) Pub. No.: US 2009/0218397 A1
(43) Pub. Date: Sep. 3, 2009

(54) Document of Value Having Security Element

(76) Inventors: Heinrich Wild, Herzogenaurach (DE); Hubert Sussner, Oberasbach (DE); Joachim Suss, Furth/Bay (DE)

Correspondence Address: HOFFMANN & BARON, LLP, 6900 JERICHO TURNPIKE, SYOSSET, NY, 11791, US

(21) Appl. No.: 12/226,848

(22) PCT Filed: May 15, 2007
(86) PCT No.: PCT/EP2007/004297

§ 371 Date: Oct. 29, 2008

(30) Foreign Application Priority Data
May 16, 2006 (DE) 10 2006 023 084.1

(51) Int. Cl. G06K 5/00; G06K 19/06

(52) U.S. Cl. 235/380; 235/493

(57) ABSTRACT

The invention concerns a value-bearing document (1) which at one of its surfaces has a security element (2) and a transfer film for the production of the value-bearing document. The security element (2) has a magnetic layer (25) for the storage of machine-readable items of information and a reflection layer (23) which is arranged above the magnetic layer (25) in relation to the surface of the value-bearing document. The reflection layer (23) and the magnetic layer (25) cover each other over at least region-wise and the reflection layer (23) is formed by a reflection layer which is not electrically conductive.

The invention concerns a value-bearing document, in particular a credit card, an identity card or pass or a ticket, which at one of its surfaces has a security element including a magnetic layer and a reflection layer. The invention further concerns a transfer film, in particular a hot embossing film, for the production of such a value-bearing document.

Value-bearing documents and embossing films of the above-indicated kind are known for example from DE 34 22 910 C1 or EP 0 559 069 B1. Thus DE 34 22 910 C1 describes an embossing film having a magnetic layer, a metal layer as well as a protective lacquer layer with a structure having an optical-diffraction effect. EP 0 559 069 B1 describes the structure of a value-bearing document having a metal layer and a magnetic layer, wherein provided between the metal layer and the magnetic layer is a barrier layer which prevents the magnetisable particles of the magnetic layer having an effect on the metal layer.

Now, in use of value-bearing documents of the above-discussed kind, it has surprisingly been found that, when reading out items of information stored in the magnetic layer of the value-bearing document, sporadic errors occur. Besides the occurrence of reading errors, the failure of the entire reading device when attempting a reading operation was also to be observed in some occasional cases.

Now the object of the invention is to minimise the occurrence of errors when reading items of information by machine out of a magnetic layer of a value-bearing document of the kind referred to in the opening part of this specification.

That object is attained by a value-bearing document which at its surface has a security element, wherein the security element has a magnetic layer for the storage of items of information which can be read out by machine and a reflection layer, wherein the reflection layer is arranged above the magnetic layer in relation to the surface of the value-bearing document, the reflection layer and the magnetic layer cover each other over at least region-wise and wherein the reflection layer is a reflection layer which is not electrically conductive.

That object is further attained by a transfer film, in particular a hot embossing film, for the production of such a value-bearing document, which has a carrier film and a transfer layer which is separable from the carrier film and which has a magnetic layer for the storage of items of information which can be read out by machine and a reflection layer, wherein the reflection layer is arranged between the carrier film and the magnetic layer and the reflection layer and the magnetic layer cover each other over at least region-wise, and the reflection layer is a reflection layer which is not electrically conductive.

In that respect the invention is based on the realisation that the reading errors occurring in relation to value-bearing documents of the kind set forth in the opening part of this specification are to be attributed to an accumulation of electrical charges on the metal layer of the value-bearing document, which is caused when using the value-bearing document by charge transport from the body of the user on to the metal layer of the value-bearing document. The charge accumulated by electrostatic charging on the body of the user is transferred on to or capacitively coupled into the metal layer of the value-bearing document in use/contact of the value-bearing document, when specific ambient conditions occur. The fact that the reflection layer according to the invention is not of an electrically conductive nature provides on the one hand that the charge accumulated on the body of the user by electrostatic charging is not transferred on to the reflection layer and accumulated there. In addition, that also provides for potential separation between a region of the reflection layer which is in communication with the human user and the region, arranged in the immediate proximity of the reading head, of the reflection layer of the value-bearing document.

A reflection layer which is not electrically conductive presents the properties of an insulator and preferably involves a specific electrical resistance of more than 10³ Ωmm²/m, preferably more than 10⁷ Ωmm²/m, at a temperature of 20° C.

The occurrence of the above-described faults is effectively prevented and the occurrence of reading errors is substantially reduced, by the use of such a reflection layer instead of a metallic reflection layer.

Advantageous configurations of the invention are set forth in the appendant claims.

In accordance with a preferred embodiment of the invention the reflection layer comprises an electrically non-conductive material or an arrangement of electrically non-conductive materials. The electrically non-conductive reflection layer thus comprises for example a single layer of an electrically non-conductive material, a plurality of successive layers which comprise different materials which however are each not electrically conductive or a dispersion of electrically non-conductive particles or pigments in an electrically non-conductive binder. In addition it is also possible for the electrically non-conductive reflection layer to comprise a dispersion of particles which exhibit a certain degree of electrical conductivity in a dielectric binder, if the reflection layer in itself is overall not electrically conductive by virtue of mutual insulation of the particles by the electrically non-conductive binder. It is essential here that a surface region of less than 100 mm² of the reflection layer is not electrical conductive and preferably that a surface region of less than 1 mm² is not electrically conductive.

The reflection layer preferably comprises one or also a plurality of dielectric layers having an optical refractive index which differs from that of the layer arranged above and/or below the reflection layer. In particular dielectric high-refraction layers (HRI=high refraction index) or low-refraction layers (LRI=low refraction index) are used as such dielectric layers. In that respect the term low-refraction layers is preferably used to denote layers whose optical refractive index is ≦1.6. Here the term high-refraction layers is preferably used to denote layers whose optical refractive index is ≧2.0.

In that respect in particular the use of inorganic dielectric high-refraction/low-refraction layers has proven its worth. Preferably silicon dioxide (refractive index n=1.5), magnesium oxide (refractive index n=1.6), aluminium oxide (refractive index n=1.6), magnesium fluoride (refractive index n=1.4), potassium fluoride (refractive index n=1.3 to 1.4), cerium fluoride (refractive index n=1.6) or aluminium fluoride (refractive index n=1.3) are used as materials for low-refraction layers. Preferably zinc sulphide (refractive index n=2.3), titanium dioxide (refractive index n=1.4), zirconium dioxide (refractive index n=2.0), zinc oxide (refractive index n=2.1), indium oxide (refractive index n=2.0), cerium oxide (refractive index n=2.3) or tantalum oxide (refractive index n=2.1) are used as materials for high-refraction layers.

Besides using layers comprising inorganic materials it is also possible to use in the reflection layer one or more layers comprising organic materials, the refractive index of which markedly differs from that of the surrounding layers. Thus, as the low-refraction layers, it is also possible to use lacquer layers comprising an organic polymer which usually exhibits low-refraction optical properties.

In accordance with this embodiment the reflection layer thus preferably comprises one or more dielectric layers which are applied over the full surface area in the region of the reflection layer for example by vapour deposition (in the case of inorganic dielectric layers) or by printing thereon (in the case of organic dielectric layers).

In accordance with a preferred embodiment the reflection layer comprises an alternate succession of a plurality of high-refraction and low-refraction layers. By way of example the reflection layer comprises an odd succession of three or more layers, wherein starting from a high-refraction layer a low-refraction layer follows a respective high-refraction layer and a high-refraction layer follows a respective low-refraction layer. By virtue of such an arrangement of layers it is possible to considerably increase the proportion of light reflected by the reflection layer. The proportions of the incident light, that are reflected at the refraction planes formed in that way, are totalled so that the percentage of the light reflected at the reflection layer correspondingly increases with the number of the refraction planes.

It has proven desirable in that respect for the layer thickness of the high-refraction and low-refraction layers in such a layer system to be so selected that the optical thickness of the layers, for the range of the light which is visible to the human eye, does not satisfy the λ/4 condition (λ=wavelength of the light). It is possible in that way to avoid troublesome interference effects. In addition however it is also possible, by virtue of a suitable choice of the layer thicknesses of the high-refraction and low-refraction layers, to produce an interference layer system which by means of interference produces a viewing angle-dependent colour shift effect.

It has surprisingly also been in that respect that the above-described structure of the reflection layer, comprising one or more low-refraction and/or high-refraction layers, in conjunction with a magnetic layer arranged under such a reflection layer, exhibits particularly good optical properties: due to the usually dark body colour of the magnetic layer under the reflection layer, a considerable proportion of the components of the incident light, that are not reflected but transmitted through the reflection layer, are absorbed by the magnetic layer, whereby troublesome interference effects, due to components of the transmitted light that are retro-reflected by the magnetic layer, are avoided and a brilliant optical result is achieved. If thus for example surface reliefs having an optical-diffraction effect are shaped into the surface of the reflection layer or a lacquer layer adjoining the reflection layer, the optical effect generated thereby, for example a hologram or a Kinegram® is clear and readily perceptible to the human viewer, even under adverse illumination conditions.

In accordance with a further preferred embodiment of the invention the non-conducting reflection layer comprises a crosslinked liquid crystal layer. In that case the crosslinked liquid crystal layer is preferably arranged over the full surface area involved in the entire region of the reflection layer. Preferably orientation of the liquid crystal molecules is effected prior to crosslinking of the liquid crystal layer. The incident light is reflected at the grating planes of the crosslinked liquid crystals. An attractive optical appearance can be achieved by the use of cholesteric liquid crystals which, by virtue of their spiral character, reflect/transmit different wavelength ranges of the light to differing degrees in viewing angle-dependent relationship and thus exhibit a viewing angle-dependent colour shift effect. In this case also further surprising advantages are afforded by the combination of such a layer with a magnetic layer arranged beneath the cholesteric liquid crystal layer. It has been found that, by virtue of the dark body colour of the magnetic layer, in this case also a large part of the light components transmitted by the liquid crystal layer is absorbed and as a result the above-discussed optically variable effect is shown to particularly good advantage.

In accordance with a further preferred embodiment of the invention the reflection layer comprises a dispersion of reflecting pigments in a dielectric binder. In that case the reflecting pigments are preferably made up of a succession of high-refraction and low-refraction layers which each comprise a dielectric material. It is however also possible for those pigments to have a metal core, preferably comprising aluminium, chromium, copper, silver or gold, or an alloy thereof. The use of reflecting effect pigments, for example interference layer pigments, is also possible.

In accordance with a further preferred embodiment of the invention the security element has a security layer which is possibly of a multi-layer structure and which is provided above the reflection layer with respect to the surface of the value-bearing document. In that case the reflection layer serves to reinforce the optical effect produced by the security layer, or an optical effect, in particular an optically variable effect, is produced only after combination of that security layer with the reflection layer. The security layer preferably has a lacquer layer in which an optical-diffraction structure is shaped. Thus for example a hologram, a Kinegram® or a diffraction grating with a spatial frequency of more than 300 lines/mm is shaped in the lacquer layer. Furthermore it is also possible for a macrostructure, for example a refractive microlens grid raster, a matt structure or an asymmetrical structure, for example a blaze grating, to be shaped into the lacquer layer. Furthermore it is also possible for the security layer to have layers which have a fluorescent or thermochromic material.

In accordance with a preferred embodiment of the invention a barrier layer is provided between the magnetic layer and the electrically non-conductive reflection layer. The magnetic layer preferably comprises a dispersion of magnetic particles in a binder, wherein the iron oxides usually employed for magnetic particles have relatively great proportions of chemically/physically bound water which can lead to ruin of dielectric, inorganic layers of the reflection layer. To prevent that, a barrier layer comprising hydrophobic inorganic pigments of large (internal) surface area is preferably arranged between the reflection layer and the magnetic layer, to effectively prevent the diffusion of water, in particular due to the hydrophobic character of the inorganic pigments and also the absorption capability thereof. The proportion by weight of such pigments in the barrier layer is preferably 10 to 30%.

The invention is described by way of example hereinafter by means of a number of embodiments with reference to the accompanying drawings in which:

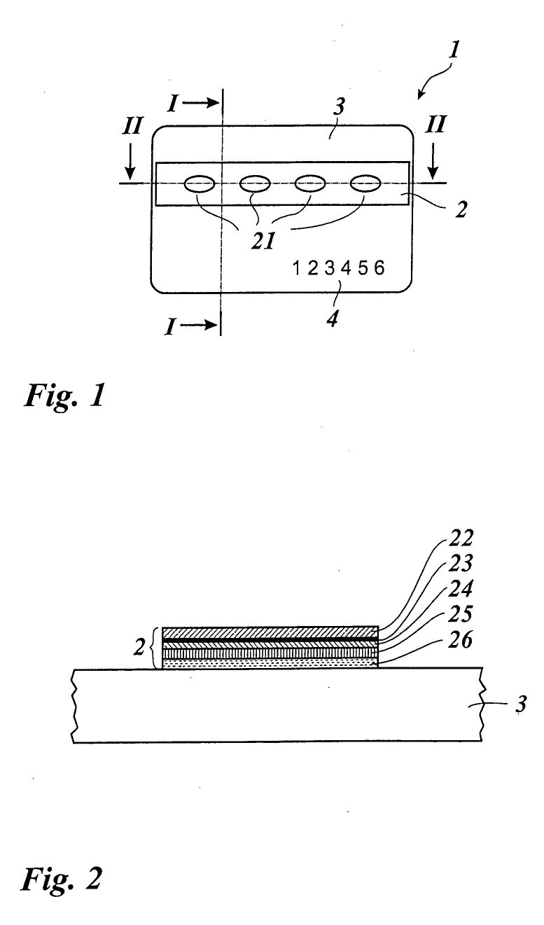

FIG. 1 shows a plan view of a value-bearing document according to the invention,

FIG. 2 shows a section along line I-I through the value-bearing document of FIG. 1,

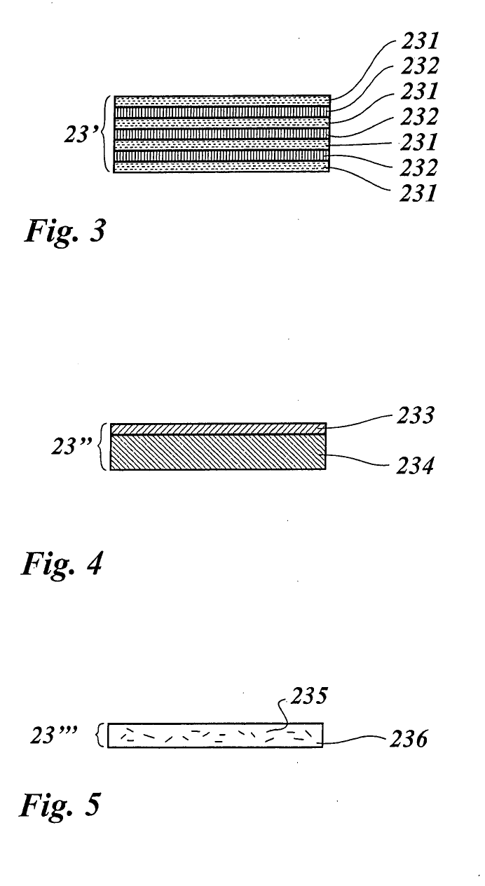

FIG. 3 shows a diagrammatic view of a reflection layer of the value-bearing document of FIG. 1,

FIG. 4 shows a diagrammatic view of a reflection layer of the value-bearing document of FIG. 1 in accordance with a further embodiment of the invention,

FIG. 5 shows a diagrammatic view of a reflection layer of the value-bearing document of FIG. 1 in accordance with a further embodiment of the invention, and

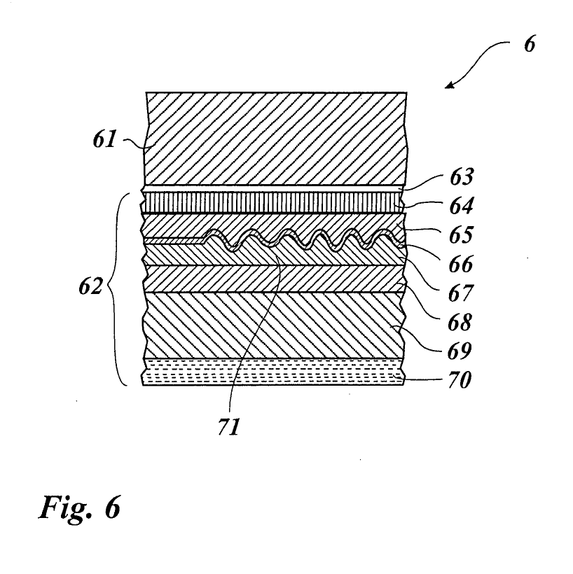

FIG. 6 shows a diagrammatic view in section of part of a transfer film according to the invention.

FIG. 1 shows the rear side of a credit card 1. On the rear surface the credit card 1 has a strip-shaped security element 2. The security feature 2 is arranged on a carrier body which is of plastic material and which is in card form and in which for example the name of the card holder and the credit card number are embossed. The strip-shaped security element 2 can extend over the entire width of the credit card 1 or—as indicated in FIG. 1—can only partially cover the width of the credit card 1. In this case the strip-shaped security element 2 is in the form of a magnetic strip, as is usually provided for credit cards for the storage of items of information which can be read out by machine. The security element 2 is thus of a width of about 10 to 12 mm and a length of for example 82 mm. In addition the security element 2 is placed on the rear side of the card 1 in the same manner as the magnetic strip of a usual credit card so that items of information which are stored in the security element 2 and which can be read out by machine can be read out by the reading head of a conventional reading device.

In contrast to usual magnetic strips the security element 2 has a reflection layer which imparts a particular optical appearance to the security element 2. Furthermore the security element 2 has a plurality of optically variable security features 21 which can be seen in reflection and which preferably involve security elements having an optical-diffraction effect such as holograms, Kinegrams® or a diffraction grating generating a kinetic effect.

Besides the security element 2 the rear side of the credit card 1 also has an identification 4 and possibly further optical security features.

The structure of the security element 2 is now diagrammatically shown by way of example in FIG. 2 illustrating a section through the credit card 1 along line I-I.

FIG. 2 shows the plastic material body 3 and the security element 2 applied to the plastic material body 3. The security element 2 has an adhesive layer 26, a magnetic layer 24 for the storage of machine-readable items of information, a bonding layer 25, a reflection layer 23 and an optical security layer 22.

The optical security layer 22 comprises a protective lacquer layer and a replication lacquer layer in which an optical-diffraction structure is introduced by means of an embossing punch or by means of UV replication. As already described hereinbefore the security layer 22, instead of or in addition to a replication lacquer layer, with an embossed optical-diffraction structure, can include one or more further layers which provide an optically distinguishable security feature, preferably in combination with the reflection layer 23. Furthermore it is also possible for the security layer 22 to have a layer with a repetitive micropattern and an optically transparent layer arranged over said layer, in which a microlens grid raster is shaped. Preferably the security layer 22 here includes one or more dielectric layers, in which respect the term ‘dielectric layer’ in this context includes both organic and also inorganic layers having dielectric properties (not electrically conducting). In that respect it is also possible for the optical security layer 22, besides one or more lacquer layers and/or inorganic layers, to also include one or more layers comprising a plastic film, for example a polyester film.

The magnetic layer 24 comprises a dispersion of magnetic pigments which are usually iron oxide, in a binder. In that case the magnetic layer is preferably of a thickness of 4 to 12 μm. In addition it is also possible for the magnetic layer 24 to comprise a sputtered layer of a magnetic material, in which case the magnetic layer can be selected markedly thinner.

The bonding agent layer 25 is of a thickness of 0.2 to 5 μm and preferably comprises an organic lacquer layer. Instead of the bonding agent layer 25 it is also possible to provide a layer system comprising one or more layers, in particular a layer system including a barrier layer which prevents the magnetisable particles of the magnetic layer from having an influence on the reflection layer 23.

The reflection layer 23 is formed by a layer comprising a high-refraction, preferably inorganic dielectric. The layer 23 thus for example comprises zinc sulphide which is applied to the layer 22 in a thickness of 10 nm to 500 nm in vacuum by vapour deposition. In addition the layer 23 can also comprise one of the other above-listed ceramic materials which have a higher refractive index than the layer 22. The layer thickness of the reflection layer 23 is preferably selected to be less than 1 μm in order as far as possible to avoid the occurrence of microcracks upon application of the security layer to the carrier body 3. Preferably the layer 23 is of a thickness of 100 nm to 400 nm.

In that case the security element 2 can be applied to the plastic material body 3 as part of the transfer layer of a transfer film. It is however also possible for one or more of the layers of the security element 2 to be applied directly to the plastic material body 3, for example by a printing process, and for the other layers, for example the optical security layer 22 and the reflection layer 23, then to be applied as part of a transfer layer of a transfer film, for example a hot embossing film, to those layers.

FIG. 3 shows a further possible structure of the reflection layer 23 by means of a section through the reflection layer along line II-II indicated in FIG. 1. FIG. 3 shows the reflection layer 23′ which is made up of a succession of seven layers, four high-refraction layers 231 and four low-refraction layers 232. As shown in FIG. 3 high-refraction and low-refraction layers alternate in the layer structure, that is to say a high-refraction layer is followed by a low-refraction layer and a low-refraction layer is in turn followed by a high-refraction layer. In accordance with a first embodiment the layer 231 comprises ZnS and the layer 232 comprises MgF₂. In accordance with a further embodiment the layer 231 comprises TiO₂ and the layer 232 comprises SiO₂. In accordance with a further embodiment the layer 231 comprises ZrO₂ and the layer 232 comprises SiO₂. In accordance with a further embodiment the layer 231 comprises TiO₂ and the layer 232 comprises MgF₂. In accordance with a further embodiment the layer 231 comprises ZrO₂ and the layer 232 comprises MgF₂. In accordance with a further embodiment the layer 231 comprises ZnS and the layer 232 comprises MgO. In accordance with a further embodiment the layer 231 comprises TiO₂ and the layer 232 comprises MgO. In accordance with a further embodiment the layer 231 comprises ZrO₂ and the layer 232 comprises MgO.

The layers 231 and 232 are produced one upon the other over the full surface area involved by vapour deposition until the layer succession shown in FIG. 3 is achieved. In that case the layer 231 is of a layer thickness of preferably less than 1 μm so that the thickness of the individual layers 231 and 232 is appropriately selected. Instead of a system comprising seven layers which are successively applied to each other by vapour deposition it is also possible to provide a larger or smaller, preferably odd number of layers 231 and 232 in the reflection layer 23′.

In this case the layer thickness of the individual layers 231 and 232 is preferably so selected that a large part of the incident light is reflected in the range of visible light and the layers arranged beneath the reflection layer 23 thus remain for the major part concealed.

That can be achieved in particular by the effective optical thickness of the layers 231 and 232 being so selected that no extinction phenomenon caused by interference comes into play for the range of visible light, that is to say for the wavelength range of 390 to 770 nm. The effective optical thickness of the layers 231 and 232 is preferably to be selected to be less than λ/2 for the wavelength range of visible light. To avoid further additive optically disturbing interference phenomena the effective optical density of the layers 231 and 232 is preferably to be selected less than λ/4 for the range of visible light.

FIG. 4 shows a further possible structure for the reflection layer 23 by means of a section through the reflection layer along the line II-II indicated in FIG. 1. FIG. 4 shows the reflection layer 23″ comprising two layers, an orientation layer 233 and a layer 234 of a liquid crystal material.

The orientation layer 232 preferably comprises a replication lacquer layer into which a relief structure has been shaped by means of an embossing tool. The relief structure comprises for example a multiplicity of parallel grooves which are arranged in mutually juxtaposed relationship and which permit orientation of liquid crystal molecules. In this case the spatial frequency of the relief structure is preferably 300 to 3000 lines/mm and the profile depth of the grooves is preferably 200 to 600 nm. It is however also possible for the orientation layer 233 to be formed by an exposed photopolymer layer. In principle it is possible to use for that purpose all photopolymers whose orientation properties can be established by irradiation with polarised light. Examples of such photopolymers (LPP=linearly photopolymerised polymers) are described for example in EP 0 611 786 A, WO 96/10049 and EP 0 763 552 A. The photopolymer layer is applied to the layer 22 by means of a wet-chemical process, then dried and exposed with polarised UV light.

In addition it is also possible to dispense with the orientation layer 233 or to impress into the layer 22 a corresponding surface structure for orientation of the liquid crystal molecules or to suitably mechanically process the layer 22 prior to application of the liquid crystal layer 234 so that a surface structure is formed, which is suitable for orientation of the liquid crystal molecules.

By way of example the liquid crystal layer 234 is applied to the orientation layer 233 by means of an intaglio printing process. In that case the liquid crystal layer 234 preferably comprises a liquid crystal material which is hardened by a beam process or which hardens in some other fashion. By way of example the liquid crystal materials described in U.S. Pat. No. 5,389,698, U.S. Pat. No. 5,602,661 A, EP 0 689 084 A, EP 0 689 065 A, WO 98/52077 or WO 00/29878 can be used as the liquid crystal material. Preferably in this respect ‘Merck RMM 129’ or ‘OPALVA®’ (Vantico-Base) is used as liquid crystal for the layer 234. The liquid crystals are then oriented if required with the application of heat. Finally UV hardening or thermally induced radical crosslinking of the liquid crystal material is effected to fix the orientation of the liquid crystal molecules. In addition it is also possible for the layer 234 comprising a solvent-bearing liquid crystal material to be subjected to a drying process and for the liquid crystal molecules to be oriented during evaporation of the solvent in accordance with the structure introduced into the orientation layer 233.

Besides the use of nematic liquid crystal material it is also possible to use cholesteric liquid crystal material which is applied to the orientation layer, oriented and then crosslinked in the same manner as described above. Furthermore it is also possible to provide the layer 23 shown in FIG. 2 or the multi-layer system 23′ shown in FIG. 3 above or beneath the layer 234.

FIG. 5 shows a further possible structure of the reflection layer 23 by means of a section through the reflection layer on line II-II indicated in FIG. 1. FIG. 5 shows the reflection layer 23′″ comprising a dispersion of reflecting pigments 235 in a dielectric binder 236.

The layer 23′″ is preferably from 1 μm to 10 μm in thickness. Preferably the reflecting pigments used are in the form of flake pigments of a mean diameter of 5 μm to 30 μm, which are made up of a plurality of successive dielectric layers, for example in accordance with the multi-layer system of FIG. 3. It is also possible to use metallic pigments, preferably comprising aluminium, as the reflecting pigments.

The layer 23′″ can be in that respect of the following composition:

| | |
|---|---|
| Methyl ethyl ketone | 260 |
| Cyclohexanone | 130 |
| Polyvinyl chloride/vinyl acetate-copolymer (Tg = 79° C.) | 110 |
| Polymethylmethacrylate (Tg = 121° C.) | 150 |
| Pigment (for example aluminium pigment) | 350 |

FIG. 6 shows a transfer film 6 for the production of the value-bearing document shown in FIG. 1. The transfer film 6 comprises a carrier film 61, a release layer 63, and a transfer layer 62 having a protective lacquer layer 64, a replication lacquer layer 65, a reflection layer 66, a bonding agent layer 67, a barrier layer 68, a magnetic layer 69 and an adhesive layer 70. The carrier film 10 is formed by plastic material film, preferably a polyester film of a thickness of 12 to 23 μm. The following layers are applied to that polyester film preferably by means of an intaglio printing process and optionally dried. In that case preferably a layer of a wax-like material is applied as the release layer 63. The protective lacquer layer 64 and the replication lacquer layer 65 are from 0.3 to 1.2 μm in thickness. The replication lacquer layer 65 comprises a thermoplastic lacquer in which an optical-diffraction structure 71, for example a hologram or a Kinegram® is embossed by means of a heated rotating embossing cylinder or by a stroke embossing procedure.

Then a layer comprising SiOₓ or ZnS is applied to the replication lacquer layer 65 by vapour deposition, of a thickness of 10 nm to 500 nm, as the reflection layer.

The bonding agent layer 67, the barrier layer 68, the magnetic layer 69 and the adhesive layer 70 are then applied by printing. The metal layer 66 is 0.01 to 0.04 μm in thickness. The bonding agent layer 12 is 0.2 to 0.7 μm in thickness. The barrier layer 68 is 0.5 to 5 μm in thickness. The magnetic layer 69 is 4 to 12 μm, preferably about 9 μm, in thickness. The adhesive layer 70 is 0.3 to 1.2 μm in thickness.

The various layers of the transfer film 6 can be of the following composition:

### Replication Lacquer Layer 65

| | Parts |
|---|---|
| Component | by weight |
| High-molecular PMMA resin | 2,000 |
| Silicone alkyde, oil-free | 300 |
| Non-ionic wetting agent | 50 |
| Methyl ethyl ketone | 750 |
| Low-viscosity nitrocellulose | 12,000 |
| Toluene | 2,000 |
| Diacetone alcohol | 2,500 |

### Reflection Layer 66

A layer of ZnS or SiOₓ applied by vapour deposition in a vacuum

### Bonding Agent Layer 67

| | Parts |
|---|---|
| Component | by weight |
| High-molecular PVC-PVAc copolymer | 1,200 |
| Methyl ethyl ketone | 3,400 |
| Toluene | 1,000 |
| Matting agent | 100 |

### Barrier Layer 68

| | Parts |
|---|---|
| Component | by weight |
| Methyl ethyl ketone | 30 |
| Toluene | 35 |
| Ethyl alcohol | 15 |
| Vinyl chloride/vinyl acetate-copolymer MP: >65° C. | 11 |
| Unsaturated polyester resin (Mp: 100° C., d = 1.24 g/cm³) | 3 |
| Silicone polyester resin (d = 1.18 g/cm³) | 2 |
| Hydrophobised silicic acid (pH ≧ 7 of a 5% slurry in H₂O | 4 |

### Magnetic Layer 69

This comprises a dispersion of γ-Fe₂O₃ magnetic pigment in needle form in a polyurethane binder, various lacquer additives and a solvent mixture of methyl ethyl ketone and tetrahydrofuran. It will be noted however that the magnetic layer does not necessarily have to be of that composition. Instead of the Fe₂O₃ pigments it is also possible for example to use other magnetic pigments, for example Co-doped magnetic iron oxides or other finely dispersed magnetic materials (Sr, Ba-ferrites). The binder combination of the magnetic layer 69 can possibly also be so selected that it is possible to dispense with the bonding agent layer because a direct bond is directly afforded on the metal, which can be of significance in the event of dispensing with the barrier layer 68.

### Adhesive Layer 70

The adhesive layer 70 can be a per se known hot melt adhesive layer. It is however not always necessary to apply that layer. That depends on the composition of the substrate of the value-bearing document, on to which the embossing film is to be embossed. If the substrate comprises for example PVC, as is mostly the case with credit cards, it is normally possible to dispense with a particular hot melt adhesive layer.

1-19. (canceled)

20. A value-bearing document which at one of its surfaces has a security element, wherein the security element has a magnetic layer for the storage of items of information which can be read out by machine and a reflection layer, wherein the reflection layer is arranged above the magnetic layer in relation to the surface of the value-bearing document, the reflection layer and the magnetic layer cover each other over at least region-wise and wherein the reflection layer is a reflection layer which is not electrically conductive and which has one or more dielectric high-refraction and/or low-refraction layers, wherein the one or more dielectric high-refraction and/or low-refraction layers each comprise a dielectric, inorganic material.

21. A value-bearing document according to claim 20, wherein the reflection layer comprises an electrically non-conductive material or an arrangement of electrically non-conductive materials.

22. A value-bearing document according to claim 20, wherein the reflection layer comprises an alternate succession of high-refraction and low-refraction layers.

23. A value-bearing document according to claim 20, wherein the layer thickness of the high-refraction and/or low-refraction layers is respectively so selected that, in the range of the light that is visible to the human eye, the optical thickness of the respective high-refraction or low-refraction layer does not comply with the λ/4-condition.

24. A value-bearing document according to claim 20, wherein the one or more dielectric high-refraction and/or low-refraction layers form an interference layer system which by means of interference produces a viewing angle-dependent colour shift effect.

25. A value-bearing document according to claim 20, wherein the reflection layer comprises a crosslinked liquid crystal layer.

26. A value-bearing document according to claim 25, wherein the liquid crystal layer comprises a cholesteric liquid crystal.

27. A value-bearing document according to claim 25, wherein an orientation layer for orientation of the liquid crystal molecules of the liquid crystal layer is provided beneath or above the liquid crystal layer.

28. A value-bearing document according to claim 20, wherein the reflection layer has a layer comprising a dispersion of reflecting pigments in a dielectric binder.

29. A value-bearing document according to claim 20, wherein the magnetic layer of the security element is shaped in the form of a strip and the reflection layer covers over the magnetic layer over the full surface area.

30. A value-bearing document according to claim 20, wherein an optical-diffraction structure is shaped in the reflection layer.

31. A value-bearing document according to claim 20, wherein, provided in the security element above or beneath the reflection layer, is a lacquer layer into which an optical-diffraction structure is shaped.

32. A value-bearing document according to claim 20, wherein the magnetic layer comprises a dispersion of magnetic particles in a binder.

33. A value-bearing document according to claim 20, wherein the magnetic layer comprises a dispersion of magnetic particles and colour pigments of a bright body colour in a binder.

34. A value-bearing document according to claim 20, wherein, provided between the magnetic layer and the reflection layer, is a barrier layer.

35. A value-bearing document according to claim 34, wherein the barrier layer is of a thickness of 2 to 3 μm.

36. A transfer film for the production of a value-bearing document according to claim 20,
wherein the transfer film has a carrier film and a transfer layer which is separable from the carrier film and which has a magnetic layer for the storage of items of information which can be read out by machine and a reflection layer, wherein the reflection layer is arranged between the carrier film and the magnetic layer and the reflection layer and the magnetic layer cover each other over at least region-wise, and wherein the reflection layer is a reflection layer which is not electrically conductive and which has the one or more dielectric high-refraction and/or low-refraction layers, wherein the one or more dielectric high-refraction and/or low-refraction layers each comprise a dielectric, inorganic material, in particular a ceramic material.
